(19) United States
(12) Patent Application Publication
(10) Pub. No.: US 2004/0119175 A1
(43) Pub. Date: Jun. 24, 2004

(54) Apparatus and method for manufacturing intraocular lenses

(76) Inventors: Bryan M. Reed, Rochester, NY (US); James O'Callaghan, Waterford (IE); William J. Appleton, Rochester, NY (US); Larry C. Hovey, Ontario, NY (US); Tadeusz Urbanowicz, Rochester, NY (US); Lamese Snow, Las Flores, CA (US); Philippe Subrin, Worb (CH); Bradley J. Adams, Newport Richey, FL (US)

Correspondence Address: Bausch & Lomb Incorporated, One Bausch & Lomb Place, Rochester, NY, 14604-2701, US

(21) Appl. No.: 10/327,580

(22) Filed: Dec. 20, 2002

(51) Int. Cl. B29D 11/00; B26D 1/143

(52) U.S. Cl. 264/1.32; 264/138; 425/810; 425/808; 425/295

(57) ABSTRACT

Apparatus and method incorporating a trephine for cutting an IOL optic from an IOL blank in a rotational cutting movement.

### BACKGROUND OF THE INVENTION

The present invention relates to the manufacture of intraocular lenses (hereinafter IOLs). More particularly, the invention relates to an apparatus and method incorporating a trephine for cutting an IOL from a blank material.

A common and desirable method of treating a cataract eye is to remove the clouded, natural lens and replace it with an artificial IOL in a surgical procedure known as cataract extraction. IOLs are available in many different configurations and materials which the surgeon chooses from based on the needs of the patient. Some of the more common IOLs include an optic and one or more but usually two haptics extending from the optic for anchoring the IOL within the eye. The IOL optic may itself be bi-convex, piano-convex, plano-concave, plano-plano, or bi-concave, for example. The optic may also include spheric and/or aspheric optics on one or more surfaces thereof. Materials from which IOLs are made include silicone, silicone acrylates, hard and soft acrylics, for example. The haptics may be of the same or different material from which the optic is formed. Presently popular IOL designs have a flexible optic formed of silicone elastomer or soft acrylic, for example, while the haptics are formed from a more rigid material such as PMMA which is a hard acrylic, for example. A flexible optic portion is desirable so that the optic may be folded and/or compressed for delivery through a relatively small incision made in the eye (e.g., about or less than 3 mm). Once in the eye, the optic resumes its original, unstressed shape. More rigid haptics are desirable so that they may function to locate and stabilize the optic within the eye. The haptics may be formed integrally with the optic or attached to the optic after the optic is formed. An example of co-molding the optic and haptics together where the optic is formed from a flexible material and the haptics are formed from a rigid material may be seen in U.S. Pat. Nos. 5,217,491 and 5,326,506 to Vanderbilt. The resultant rod of composite material is then machined (e.g., milled or lathed) into the final IOL shape including both the optic and haptic portions thereof.

Various methods for making IOLs have been proposed in the prior art, with molding and milling/lathing being the most popular.

### SUMMARY OF THE INVENTION

The present invention provides an apparatus and method for making an IOL which incorporates a trephine for cutting the IOL optic from a blank material of silicone, for example. The IOL blank is preferably molded and then polished for a smooth surface. The trephine then cuts and defines the IOL optic peripheral edge which requires no further polishing as is required in many of the prior optic forming methods. The trephine may be mounted within a fixture having a work piece holder upon which the blank material may be positioned for cutting. In a preferred embodiment, the blank material is moved relative to the trephine in a simultaneous rotating and linear translation to make the cut. The blank is preferably supplied in a disc form with the trephine cutting the disc at a location which is radially inward of the outer periphery of the disc. As such, the trephine cuts the desired optic diameter while leaving an outer ring of material which is discarded or recycled. The trephine is preferably removable from the fixture such that it may be quickly and easily replaced when the blade thereof is worn, or when it is desired to change to a trephine having a different optic cutting diameter.

The resultant optic is formed with a straight peripheral wall that extends substantially parallel to the optical axis of the IOL optic. At least the juncture of the optic posterior surface and peripheral wall form a sharp peripheral edge which has been clinically shown to help reduce the occurrence of posterior capsular opacification (PCO) or secondary cataracts.

The fixture may also include an optic release mechanism for lifting the cut optic from the fixture for easy retrieval thereof with a pair of tweezers, for example.

### BRIEF DESCRIPTION OF THE DRAWING

FIG. 1a is a side elevational, cross-sectional view of a preferred embodiment of the invention showing the IOL cutting mechanism in the ready position and the upper punch shown in spaced relation thereto;

FIG. 1b is a cross-sectional view of the IOL cutting mechanism taken generally through the line 1b-1b of FIG. 1a;

FIG. 2 is a plan view of a prior art IOL;

FIG. 3a is the view of FIG. 1a with a portion of the IOL cutting mechanism shown in the raised position for retrieval of the cut IOL;

FIG. 3b is a cross-sectional view of the IOL cutting mechanism taken generally through the line 3-3b of FIG. 3a;

FIG. 4a is a side elevational view of the trephine holder;

FIG. 4b is a top plan view thereof;

FIG. 4c is a cross-sectional view taken generally through the line 4c-4c of FIG. 4b;

FIG. 5a is a side elevational view of the trephine blade;

FIG. 5b is a top plan view thereof;

FIG. 6a is a side elevational view of the lens pusher,

FIG. 6b is a detail view of the lens-engaging end thereof;

FIG. 6c is a top plan view thereof, and

FIG. 7 is a scanning electron microscope image at 50× magnification showing an IOL peripheral wall which was cut using the invention.

### DETAILED DESCRIPTION OF THE PREFERRED EMBODIMENT

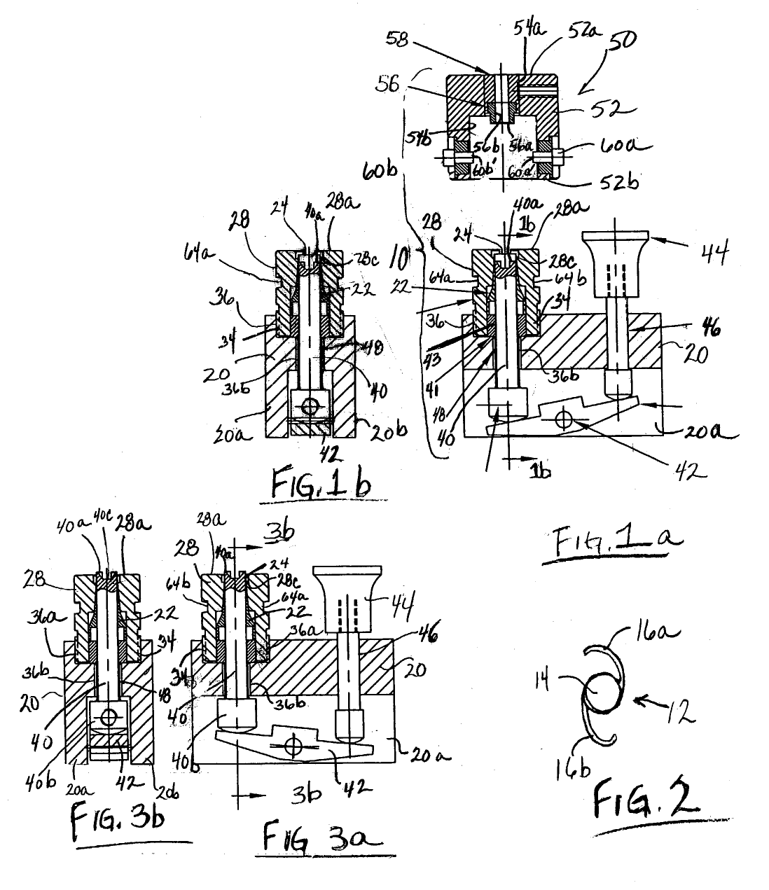

Referring now to the drawing, there is seen in FIG. 1a an IOL cutting fixture 10 useful for cutting an IOL optic from an IOL blank. A representative IOL 12 is seen in FIG. 2 to include an optic 14 and two haptics 16a and 16b. The optic 14 is provided to provide focusing within the eye while the haptics provide locating means for proper positioning of the IOL within the eye. It is understood that the particular configuration of IOL 12 is provided for discussion purposes only and may vary from that shown herein (e.g., the IOL may include one or more haptics of any configuration and the IOL anterior and posterior optic surfaces may likewise vary). The invention is used for cutting the optic portion 14 of an IOL where the haptic portions are subsequently attached to the optic using any known means (e.g., gluing).

The IOL blank (not shown) from which the optic 14 is to be cut using the present invention is in the shape of a circular disc having anterior and posterior optical surfaces of the desired configuration (e.g., convex, concave or plano and may incorporate spherical and/or aspherical optics). The IOL blank itself may be molded using a metal mold, for example, and have the holes formed into the periphery for the subsequent staking of the haptics to the optic. Fixture 10 is therefore used for cutting a finished, square edge of the optic from the blank. Square edges at the periphery of an IOL optic have been clinically shown to help reduce the occurrence of posterior capsular opacification (PCO) or secondary cataracts as noted above.

Fixture 10 includes a base 20 to which a trephine 22 is mounted having a circular cutting edge 24 at one end thereof and a longitudinally extending bore 26 extending entirely therethrough from cutting edge 24 to the opposite, base end 28 thereof (see also FIGS. 5a,b). The diameter of the cutting edge 24 is selected to correspond to the desired resultant optic diameter (e.g., about 5-7 mm, and more preferably about 6 mm). The IOL blank diameter from which the finished optic is to be cut using fixture 10 is of course larger than the resultant cut diameter of the optic and may be in the range of about 7-9 mm and more preferably is about 8 mm in diameter.

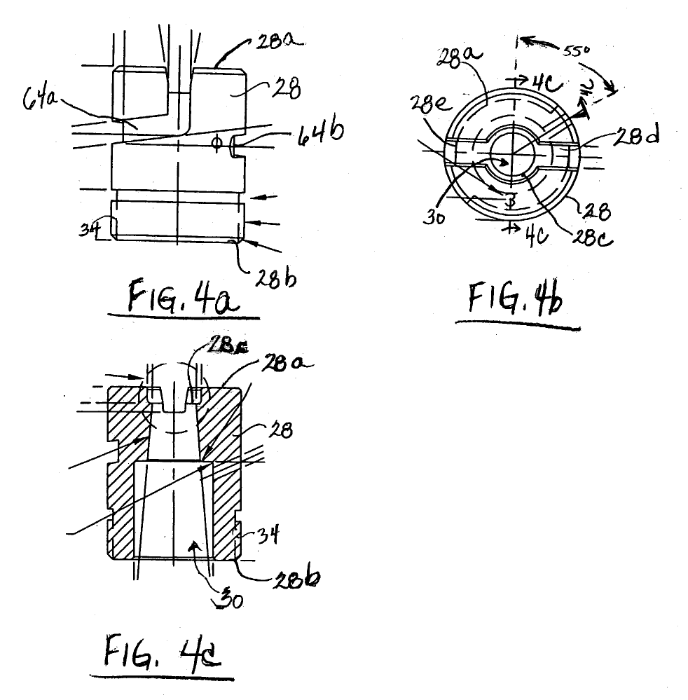

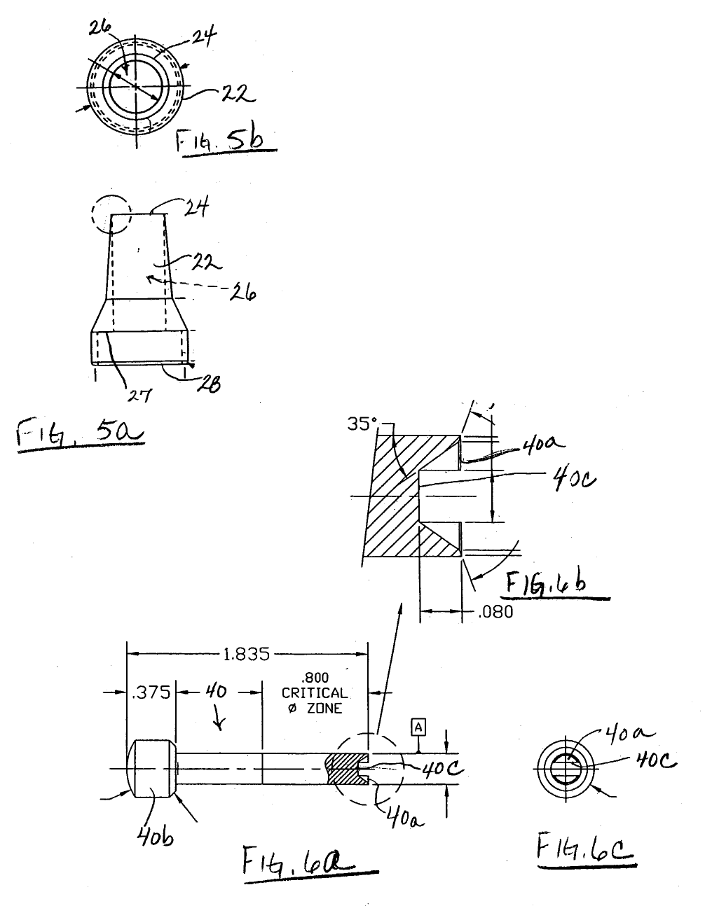

Trephine 22 is removably mounted within a trephine holder 28 having a longitudinal bore 30 extending entirely therethrough from top end 28a to bottom end 28b thereof (see also FIGS. 4a-c). Bore 30 is sized and configured so that the trephine 22 may be inserted therein from bottom end 30 and come to rest at a position therein with the trephine cutting edge 24 located slightly above the counter-sunk top surface 28c. Trephine 22 and trephine holder 28 are removably mounted to base 20 via mating threads 34 formed adjacent the bottom end 28b of holder 28 and along the inner wall of a counter-sunk bore 36 formed in the top of base 20. Since the component parts are removably mounted to each other, the trephine 22 may be quickly exchanged for a new trephine when the cutting edge 24 thereof becomes dull or it is desired to switch to a different diameter cutting edge.

A lens pusher 40 is provided which extends through bore 36b and continues through the trephine central bore 26. The bottom end 40b of pusher 40 rests upon a rocker component 42 which itself is pivotally mounted between the spaced, parallel legs 20a and 20b of base 20. Lens pusher 40 is thus mounted for reciprocal longitudinal movement within trephine 22 and trephine holder 28. Accordingly, lens pusher 40 may be moved between the lowered position seen in FIGS. 1 a,b where the top end 40a thereof is located below the counter-sunk top surface 28c of trephine holder 28, to the raised position seen in FIGS. 3a,3b where the top end 40a thereof is located above the counter-sunk top surface 28c of trephine holder 28. Reciprocal movement may be imparted by way of a pusher rod 44 which extends through another bore 46 formed in base 20 which extends parallel to bores 36a,b. The bottom end 44b of pusher rod 44 rests upon the end of rocker component 42 opposite lens pusher end 40b.

It is noted that lens pusher 40 is biased in the lowered position seen in FIGS. 1a,1b by a spring 48 which surrounds the lens pusher shaft. The spring top end bears against the bottom surface 41 of bushing 43 (see FIG. 1a) and the spring bottom end bears against the ledge of the bottom end 40b of lens pusher 40. Thus, lens pusher 40 may be moved from the biased, lowered position to the raised position seen in FIGS. 3a,b by simply pressing downwardly on pusher rod top end 44. Further explanation of this movement will be explained below.

Discussion is now turned to the upper punch mechanism 50 and the process by which an IOL optic is cut from an IOL blank. Referring to FIG. 1a, upper punch mechanism 50 is seen to include a main body portion 52 having a top surface 52a and a bottom end 52b with first and second, longitudinally extending bore portions 54a and 54b. Bottom bore portion 54b has an inner diameter slightly larger than the outer diameter of trephine holder 28 such that punch body portion 52 may be mounted upon trephine holder 28. A lens press insert 56 is mounted within upper bore portion 54a via an insert holder 58 which is slip-fit within bore 54a. The bottom edge 56a of lens press insert 56 is located at a position below upper bore portion 54a and within lower bore portion 54b. A pair of pins 60a,b are inserted via bearings 62a,b through the wall of body 52 with the pin ends 60a′, 60b′ extending radially into lower bore 54b. Pins 60a,b are preferably about 180° offset from each other. A pair of helically extending grooves 64a, 64b are formed in the outer surface of trephine holder 28 whereby pin ends 60a′, 60b′ may be inserted into the top end of the grooves adjacent top surface 28a (see FIG. 4a). The grooves first extend longitudinally toward bottom end 28b and then extend in a spiral pattern around the trephine holder body.

To begin the cutting process, a circular IOL blank is placed upon the trephine cutting edge 24 which is located slightly above the counter-sunk surface 28c of trephine holder 28 yet below the trephine holder upper surface 28a. The upper surface 28a defines a circular counter-sunk surface 28c as seen best in FIG. 4b. The outer diameter of the counter-sunk surface 28c is sized to approximate the diameter of the IOL blank being placed therein such that the IOL blank becomes centered on the trephine cutting edge 24. With the IOL blank resting on trephine cutting edge 24, the upper punch body 52 is lowered onto the trephine holder 28 with pin ends 60a′, 60b′ aligned with respective grooves 64a, 64b formed in holder 28. Since the grooves first extend longitudinally toward holder bottom edge 28b, the punch body 52 will translate linearly in a telescoping movement onto trephine holder 28. Upon reaching the end of the longitudinally extending section of the grooves, the lens press insert bottom edge 56a rests lightly upon the IOL blank. The operator then rotates punch body 52 with pin ends 60a′, 60b′ riding along the helical extents of grooves 64a, 64b whereby the lens press insert 56 pushes against the IOL blank, forcing it into the trephine cutting edge 24 which itself remains stationary. It is understood, however, that variations in operation may be made so that the trephine instead moves into the IOL blank which is held stationary. The trephine and IOL blank may also move together into one another if desired.

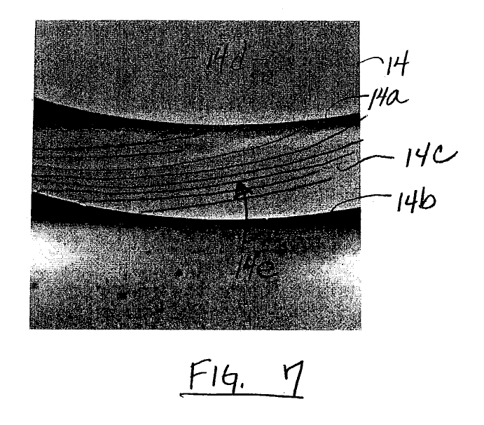

It will be realized that the above-described rotation of the punch body 52 relative to the trephine holder 28 causes the trephine cutting edge 24 to cut through the IOL blank. It is noted that the lens press insert 56 includes a longitudinal bore 56b extending therethrough. This is provided so that the central optical surface of the IOL blank is not touched by the lens press insert which could potentially cause harm to the optical surface. The diameter of the lens press insert bottom edge 56a is sized to so that the IOL blank is sandwiched between the insert and the trephine cutting blade 24. Once the IOL blank has been cut, the punch body is rotated in the opposite direction and removed from the trephine holder 28, leaving the cut IOL optic resting on the trephine cutting blade 24. The annular flash which has been cut from the optic is located around the cutting edge 24 on counter-sunk surface 28c. To remove the flash, the operator uses tweezers, extending them within either radial relief 28d or 28e formed in the top surface of the trephine holder 28 (see FIG. 4b). With the flash removed, the operator moves the lens pusher 40 to the raised position by pressing downwardly on pusher rod 44 as explained above. With the cut IOL optic resting on the top end 40a of pusher 40, the IOL optic is readily accessible for retrieval thereof. The operator may thus retrieve the cut IOL optic using a pair of tweezers, for example, by extending the tweezer tips through the relief 40c formed in top end 40a (see FIGS. 6a-c).

Attention is turned to FIG. 7 which is a scanning electron microscope image of an IOL optic cut using the present invention. The resultant peripheral wall 14c is defined between anterior and posterior peripheral edges 14a, 14b which are located at the junctures of the anterior optic surface 14d and opposite posterior optic surface, respectively (not shown). Helical striations 14e are seen in peripheral wall 14c which are a result of the rotational movement of the trephine cutting edge 24. These striations 14e may contribute to a decrease in unwanted glare caused by reflection of light off the edge of the implanted optic.

While the invention has been described with reference to a preferred embodiment thereof, it will be appreciated by those skilled in the art that various modifications may be made thereto without departing from the full spirit and scope of the invention as defined by the claims which follow. For example, one or more of the movements of fixture 10 may be automated and incorporated into other IOL processing stations such as haptic attachment and inspection, for example.

What is claimed is:

1. A method for cutting an IOL optic having opposite anterior and posterior surfaces and a peripheral wall extending therebetween out of an IOL blank, said method comprising the steps of:
a) providing a circular cutting edge;
b) providing a lens press having a circular lens-engaging end;
c) positioning said IOL blank between said circular cutting edge and said circular lens-engaging end of said lens press;
d) moving said lens press and said cutting edge toward one another in a rotational translation with said cutting edge rotationally cutting through said IOL blank and thereby forming said IOL optic.

2. The method of claim 1 wherein said circular cutting edge is defined on one end of a trephine.

3. The method of claim 2 wherein said IOL blank is circular having a diameter of between about 7 to 9 mm and said cut IOL optic has a diameter of between about 5 to 7 mm.

4. The method of claim 3 and further including the step of providing a trephine holder having a circular counter-sunk surface wherein said cutting edge is located and said IOL blank is centered prior to cutting.

5. The method of claim 4 and further providing the step of providing a lens pusher having a lens-engaging end and extending coaxially through said trephine, said lens pusher being movable between raised and lowered positions wherein said lens-engaging end of said lens pusher is positioned above and below said cutting edge, respectively.

6. The method of claim 5 and further comprising the step of biasing said lens pusher in the lowered position.

7. The method of claim 6 and further comprising the step of providing an upper punch body wherein said lens press is located, said upper punch body being removably mountable upon said trephine holder.

8. The method of claim 7 wherein said upper punch body has a longitudinally extending bore and includes one or more pins extending radially into said bore, and wherein said trephine holder includes one or more grooves which align and engage with said one or more pins to perform said rotational cutting movement.

9. Apparatus for cutting an IOL optic having opposite anterior and posterior surfaces and a peripheral wall extending therebetween out of an IOL blank, said apparatus comprising:
a) a circular cutting edge;
b) a lens press having a circular lens-engaging end with said IOL blank positionable between said circular cutting edge and said circular lens-engaging end of said lens press;
wherein said IOL optic is formed by moving said lens press and said cutting edge toward one another in a rotational translation with said cutting edge rotationally cutting through said IOL blank and thereby forming said IOL optic.

10. The apparatus of claim 9 wherein said circular cutting edge is defined on one end of a trephine.

11. The apparatus of claim 10 wherein said IOL blank is circular having a diameter of between about 7 to 9 mm and said cut IOL optic has a diameter of between about 5 to 7 mm.

12. The apparatus of claim 11 and further comprising a trephine holder having a circular counter-sunk surface wherein said cutting edge is located and said IOL blank is centered prior to cutting.

13. The apparatus of claim 12 and further comprising a lens pusher having a lens-engaging end and extending coaxially through said trephine, said lens pusher being movable between raised and lowered positions wherein said lens-engaging end of said lens pusher is positioned above and below said cutting edge, respectively.

14. The apparatus of claim 13 and further comprising means biasing said lens pusher in the lowered position.

15. The apparatus of claim 14 and further comprising an upper punch body wherein said lens press is located, said upper punch body being removably mountable upon said trephine holder.

16. The apparatus of claim 15 wherein said upper punch body has a longitudinally extending bore and includes one or more pins extending radially into said bore, and wherein said trephine holder includes one or more grooves which align and engage with said one or more pins to perform said rotational cutting movement.
